(19) United States
(12) Patent Application Publication
(10) Pub. No.: US 2014/0347709 A1
(43) Pub. Date: Nov. 27, 2014

(54) METHOD AND APPARATUS FOR FORMING DIGITAL IMAGES

(71) Applicant: STMicroelectronics, Inc., Coppell, TX (US)

(72) Inventor: Francis C. STAFFORD, Meridian, ID (US)

(73) Assignee: STMicroelectronics, Inc., Coppell, TX (US)

(21) Appl. No.: 13/898,889

(22) Filed: May 21, 2013

(51) Int. Cl. H04N 1/195; H04N 1/00; H04N 1/024

(52) U.S. Cl. CPC H04N 1/19594; H04N 1/02409; H04N 1/00559
USPC 358/479

(57) ABSTRACT

A method and apparatus for acquiring a corrected digital image of an object includes a digital camera operable to capture a plurality of color component images, an imager body and a support arm. The support arm is coupled to the imager body and adapted to support the digital camera. An image processor is provided to produce corrected color component images and an image combiner is provided to combine the corrected color component images to form the corrected digital image. The camera is moveable to more than one position to enable to formation of three-dimensional images or images with increased depth of focus.

### CROSS-REFERENCE TO RELATED APPLICATIONS

This application is related to co-pending U.S. patent application Ser. No. ______, Attorney Docket Number 10-PL-1042US01, filed on even date herewith, which is hereby incorporated herein in its entirety.

### BACKGROUND

Image scanners form a digital image of a document or object by moving a sensor, such as scan bar, in a scan path across the document or object. Scanners are sometimes combined with printers to facilitate reproduction of the scanned image. Many types of image scanners are known in the prior art, such as flat bed scanners, wand scanners and rotation drum scanners. Most conventional scanners use charge coupled devices (CCDs) or Contact Image Sensors (CISs) to sense light reflected from the document or object.

Cameras have long been used as a means to capture images. More recently, high resolution digital cameras have been used to provide an alternative to scanners. Digital cameras with resolution of 8 megapixels or more are able to formed an image comparable with a 300 dpi (dots per inch) conventional scanner. For example, the Lexmark Genesis S815 printer/scanner uses a 10-megapixel monochrome CMOS sensor with red, green and blue LEDs positioned on either side. To scan, the LEDs perform a quick double flash of red, then green, then blue. The sensed images are then combined to produce a composite color image. Unlike scanners, no scan path is required. Hence, the cost of mechanical components to provide relative motion between the sensor and document is avoided.

Digital cameras, such as CMOS cameras, have the advantage of being very small and inexpensive and also provide very fast images, since movement along a scan path is not required.

However, the disadvantages of existing digital camera based imagers include: reduced image quality due to focusing field curvature, distortions and chromatic aberrations, as well as light and resolution fall off towards the corners. In addition, the imaging of objects with variable thickness, or varying height, is difficult with a fixed focal length camera. Variable focus cameras are more expensive.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example inkjet printer of the prior art.

FIG. 2 is an example printer and imager showing a deployed imager in accordance with some embodiments of the invention.

FIG. 3 is an example printer and imager showing a retracted imager in accordance with some embodiments of the invention.

FIG. 4 is a flow chart of a method for digital imaging in accordance with some embodiments of the invention.

FIG. 5 is a flow chart of a further method for digital imaging in accordance with some embodiments of the invention.

FIG. 6 is an example imager showing a variable camera height in accordance with some embodiments of the invention.

FIG. 7 is an example imager showing a variable camera perspective angle in accordance with some embodiments of the invention.

FIG. 8 is a block diagram of an exemplary apparatus for acquiring a corrected digital image of an object, in accordance with certain aspects of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the creation of digital images. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions of digital image creation described herein. The non-processor circuits may include, but are not limited to signal drivers, clock circuits, power source circuits, memory components, mechanical components, optical components and user input devices. As such, these functions may be interpreted as a method to create digital images. Alternatively, some or all image processing functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

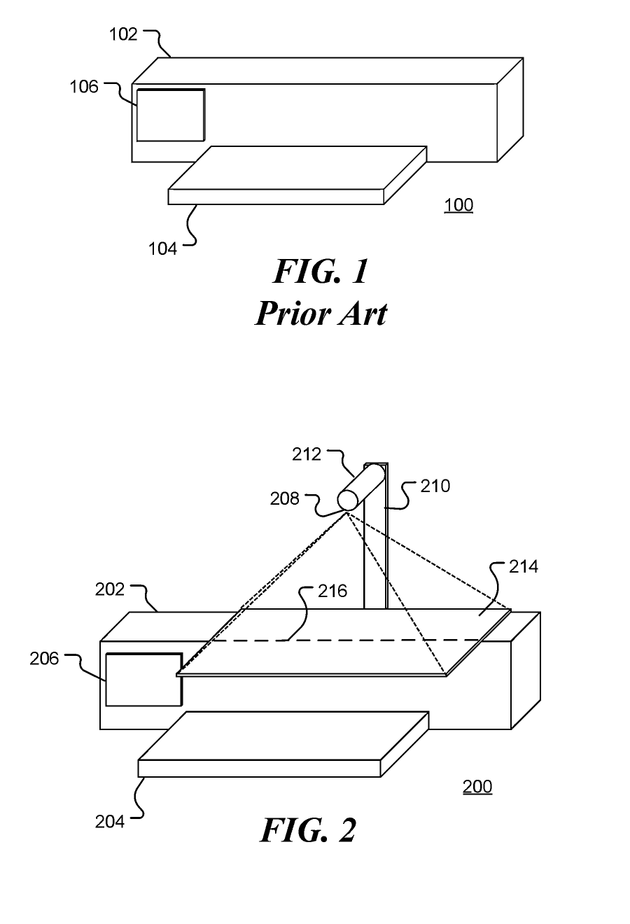

FIG. 1 is an example inkjet printer. Referring to FIG. 1, the printer 100 comprises a printer body 102 that houses the printing head, ink cartridges and paper transport mechanism, a paper output tray 104 for collecting printed pages and a control panel 106, such as a touch control display, to enable user control of printer functions. Inkjet printers may have a relatively small footprint compared to conventional flatbed document scanners.

Some embodiments of the disclosure relate to an apparatus for acquiring a corrected digital image of an object. The apparatus includes a digital camera operable to capture a plurality of color component images corresponding to a plurality of color components of light from the object. The camera is coupled to an imager body by a support arm. An image processor is operable to process the plurality of color component images to produce a plurality of corrected color component images, and an image combiner is operable to combine the plurality of corrected color component images to form the corrected digital image. The image processor may include an illumination correction module and a distortion correction module for each of the plurality of color component images.

In one embodiment, the corrected digital image of an object is obtained by first capturing color component images of the object from a camera supported by a support arm and located at one or more positions relative to the object. The color component images are processed dependent upon the color of each color component image to produce corrected color component images, which are then combined to form the correct digital image. The processing includes correcting for distortions in the color component images.

For convenience of a user, the imager may be combined with a printer, as shown in FIG. 2. FIG. 2 is an example printer and imager in accordance with some embodiments of the disclosure. The imager 200 comprises an imager body 202. When the imager is combined with a printer, as in the embodiment shown in FIG. 2, the imager body 202 may house the printing head, ink cartridges and paper transport mechanism and a paper output tray 204 is provided for collecting printed pages. A control panel 206, such as a touch control display, enables user control of imager and/or printer functions. The imager further comprises a camera 208, such as a CMOS camera, a support arm 210, which incorporates a camera mounting region 212, and a document imaging tray 214. The camera mounting region 212 may also support one or more illumination sources.

In one embodiment of the disclosure, an illumination source directs substantially white light towards the imaging tray 214 and the camera 208 is a color camera that may include a color filter array (CFA) of color filter mosaic (CFM) overlying a pixel sensor array. For example, in a Bayer color filter mosaic, each pixel sensor of the pixel sensor array is covered by a two-by-two sub-mosaic that contains 2 green, 1 red and 1 blue filter. Other mosaics are known to those of ordinary skill in the art, as are other methods (such as dichroic mirrors) for selecting the wavelength range of the light falling on a pixel sensor array. Use of a color filter mosaic produces a plurality of interlaced color component images.

In a further embodiment, the illumination source provides different colored light in a sequence. The sequence may be red, green, blue, for example. In this embodiment, a color filter mosaic is not required. The sequence of illuminations enables a plurality of color component images to be captured.

A combination of these approaches may be used.

In one example embodiment, the camera 208 is a CMOS camera. The camera 208 may have a fixed focal length for application where low cost is required. Alternatively, the camera may have a variable focal length to improve image quality. Suitable cameras are manufactured in very large quantities for use in portable electronic devices, such as mobile telephones, and are therefore inexpensive.

For a diffraction limited lens, the numerical aperture (NA) of the lens is related to the resolution R by the expression:

$$NA = \frac{R}{1.22 λ} ,$$

where λ is the wavelength of the light. For example, for a camera with having a 1.4 μm pixel pitch, which is typical of an 8 megapixel camera, the numerical aperture should be less than approximately 2.4, in order to avoid the diffraction limitation for a camera having a 1.4 μm pixel pitch, which is typical of an 8 megapixel camera. However, lenses with an NA greater than approximately 2.8 are less expensive and have a greater depth of field. Further, inexpensive lenses have a curved focal field and so benefit from a greater depth of focus. Thus, there is a design compromise in the choice of lens.

In an exemplary embodiment, shown in FIG. 2, the support arm 210 is sized to support the camera 208 at approximately 7 inches above the imaging tray, so as to satisfy the design compromise described above. In this embodiment, the required field of view for an 8.5″×11″ document is approximately 94°. This results in an image distortion of greater than 10% at the document corners. In addition, the illumination at the corners is approximately 50% of the illumination in the center, so the illumination is non-uniform.

Both the distortion and non-uniform illumination may be reduced by increasing the distance from the camera 208 to the imaging tray 214, but this is done at the expense of compactness.

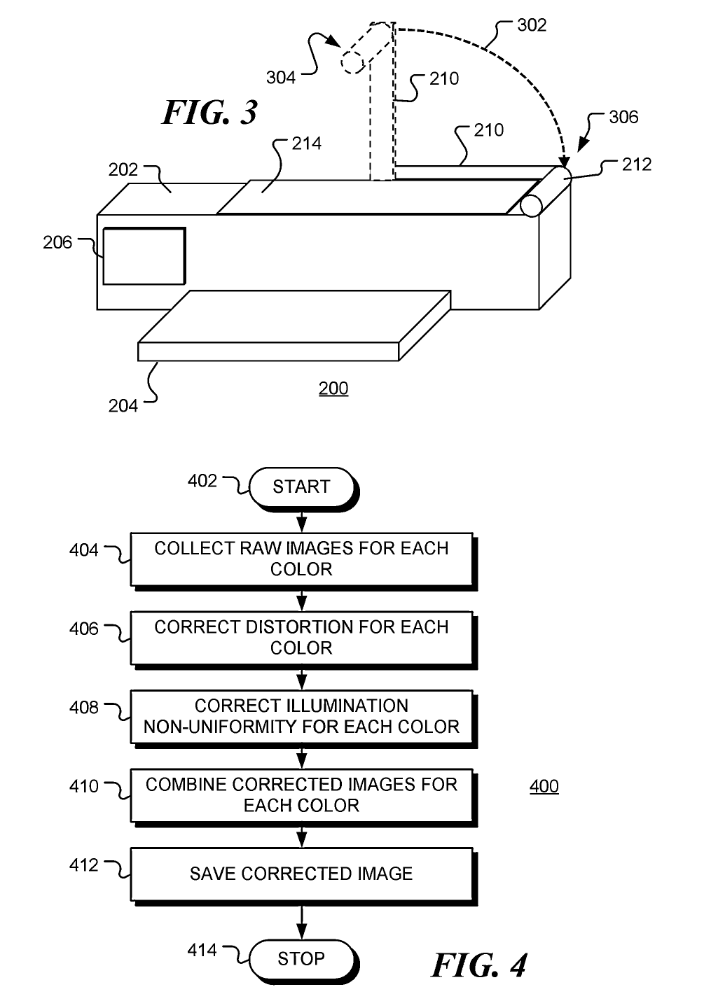

FIG. 3 is an example printer and imager showing a retracted imager in accordance with some embodiments of the disclosure. In the embodiment shown in FIG. 3, the support arm 210 is attached to the printer body 202 at a pivot, thereby allowing the imager, which comprises the support arm 210, the attached or integrated camera mounting arm 212, and the camera 208, to be rotated as indicated by broken arrow 302, from the deployed position 304 to a retracted or stowed position 306. Further, the imaging tray 214 may be folded along a hinge (216 in FIG. 2). These two operations reduce the size of the printer and imager, to facilitate transportation, for example. In addition, the imager is less likely to be damaged when in the retracted or stowed position 306.

In the exemplary embodiments described above, the imager is integrated with a printer to enable local printing of scanned documents. However, the imager may be used as a stand-alone device or as a device integrated with other electronic or non-electronic equipment.

FIG. 4 is a flow chart 400 of a method for digital imaging in accordance with some embodiments of the disclosure. The method may be used to process images captured by a digital camera. Following start block 402 in FIG. 4, one or more a raw images are captured at block 404. The one or more images may comprise a color mosaic image, obtained by use of a color filter array, or a sequence of different color images obtained by illuminating using different color light. At block 406, distortion correction for each color is performed. Since the refractive index of a lens is dependent upon the wavelength of the light, not all light is focused on the same point. This type of distortion is called chromatic distortion or chromatic aberration. Performing distortion correction for each of number of wavelengths improves the overall quality of the image, in particular reducing the amount of ‘fringing’ seen at the edges of bright regions in the image. A variety of distortion correction techniques are known to those of ordinary skill in the art. For example, the technique may utilize a mathematical model of radial distortion based on camera and lens projection geometry. Other techniques correct for an estimated point spread function (PSF) by performing a de-convolution operation, in which each pixel value is replaced by a value dependent upon the original pixel value and neighboring pixel values.

Using a larger number of colors (wavelengths) provides a higher quality image. In particular, three or more than three colors may be used. At block 408, an illumination correction is applied to each color to compensate for the non-uniform illumination of the object being imaged. The non-uniformity is a function of wavelength. This effect is negligible if the non-uniformity is less than approximately 10%. However, for the case of 50% non-uniformity there is an inherent loss of 1-bit of contrast data for the weakly illuminated pixels, and it is important to avoid further contrast losses. A variety of techniques for illumination correction are known to those of ordinary skill in the art. The corrected images for each color are combined at block 410 and the combined image is saved, or output, at block 412. The method terminates at block 414.

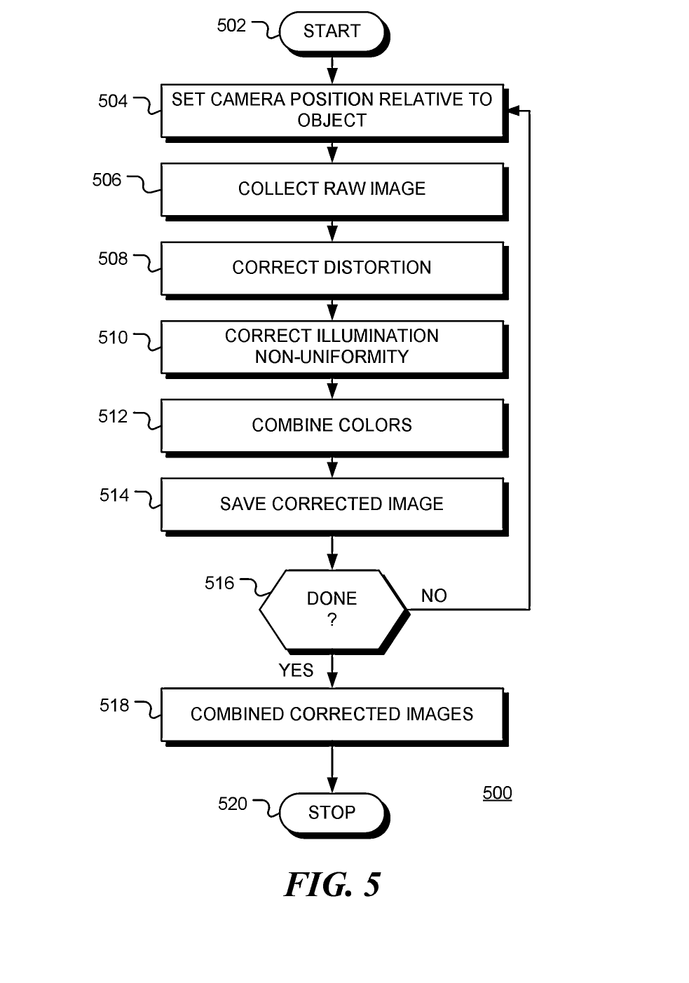

FIG. 5 is a flow chart 500 of a further method for digital imaging in accordance with some embodiments of the disclosure. Following start block 502 in FIG. 5, the position of the camera is set relative to the object at block 504. One or more raw digital image for one or more component colors are acquired at block 506. For each component color, the image is corrected for distortion at block 508 and for illumination non-uniformity at block 510. At block 512 the images for each component color are combined into a single color image. In accordance with certain embodiments of the present disclosure, images are acquired from a plurality of camera positions. At block 514 the correct image is saved to a memory, displayed, printed and/or transmitted to another location. If all of the images have been acquired, as indicated by the positive branch from decision block 516, the plurality of corrected images are combined at block 518, to be saved, output or displayed, and the process terminates at block 520. If another image is to be acquired, as indicated by the negative branch from decision block 516, flow returns to block 504. At block 504, the position of the camera may be moved to a new distance from the object or a new perspective angle relative to the object. Alternatively, the position may remain unchanged and the object illuminated with a different color light. In this manner, a plurality of images is obtained, corresponding to different colors and/or different camera positions.

In accordance with certain embodiments of the disclosure, images of an object are acquired using a camera at two or more positions.

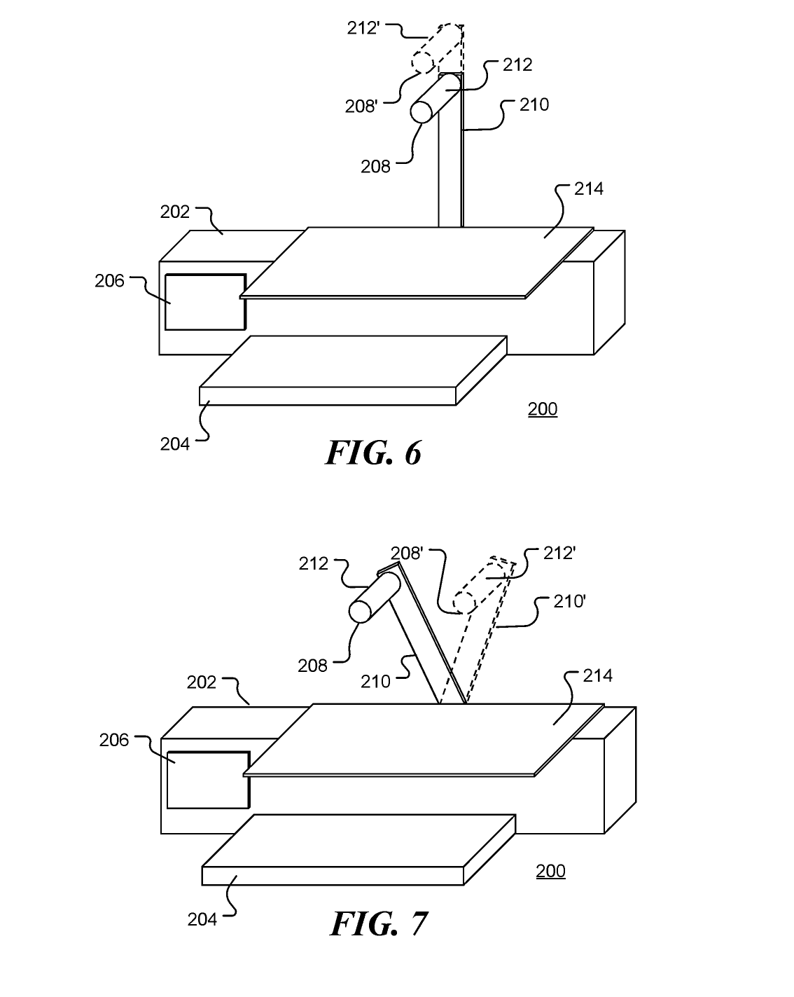

In one example embodiment, the camera is positioned at two or more different heights above the image as shown in FIG. 6. In FIG. 6, the height of the camera 208 is altered by adjusting the length of the support arm 210. This adjustment may be made automatically by use of a linear electric motor, by use of a rotational electric motor driving and a screw mechanism, or by other means. Changing the height of the camera adjusts the position of the object being imaged relative to the focal plane of the camera. Any particular area of the object may be better focused in one image than another image. Thus, a combination image may be formed by combining the best focused regions from each image. This is related to a technique known a multi-focus imaging, in which a camera with an adjustable focal length is used to acquire multiple images. Referring to FIG. 6, increasing the height of the support arm 210 moves the camera mounting arm from 212 to 212′ and moves the camera from 208 to 208′.

The height of the camera 208 may adjusted manually or automatically to adjust the focus of the camera. In one example embodiment, a sequence of images may be taken and displayed to the user as a video to allow manual height adjustment. In a further embodiment, the sequence of images is processed to find the one that is best focused (by looking at the relative sharpness of edges, for example). In one illustrative embodiment, each pixel region in the corrected image is obtained by selecting between corresponding pixel regions in corrected color component images collected from different heights. The selection is dependent upon a measure of the focus in the corresponding pixel regions.

This approach may be used for documents, such as books that have variable thickness. The video display may also be used to enable accurate positioning of the object to be imaged. The video may be displayed locally on a screen mounted on the imager body 202, or may be displayed on a remote screen, coupled to the imager via a wired, wireless or network link. Similarly, the height adjustment may be controlled locally or remotely.

In a further embodiment, the camera is positioned at two or more different perspective angles to the object being imaged, as shown in FIG. 7. In FIG. 7, the angle of the camera 208 relative to the document imaging tray 214 is altered by adjusting the angle of the support arm 210 relative to the imager body 202. This adjustment may be made automatically by use of an electric motor or by other means. In a further embodiment, the perspective angle is changed by horizontal motion of the camera 208 relative to the document imaging tray 214. This may be achieved by moving the support arm 210, the camera mounting arm 212 or the document imaging tray 214. Images taken from the different perspective angle are used to construct a three-dimensional image of the object being imaged. In FIG. 7, the support arm 210 is coupled to the imager body 202 at a pivot joint that allows it to rotate. The support arm 210 is rotated to 210′, such that the camera mounting arm 212 moves to 212′ and the camera 208 is moved to 208′. In this way, the perspective angle is changed.

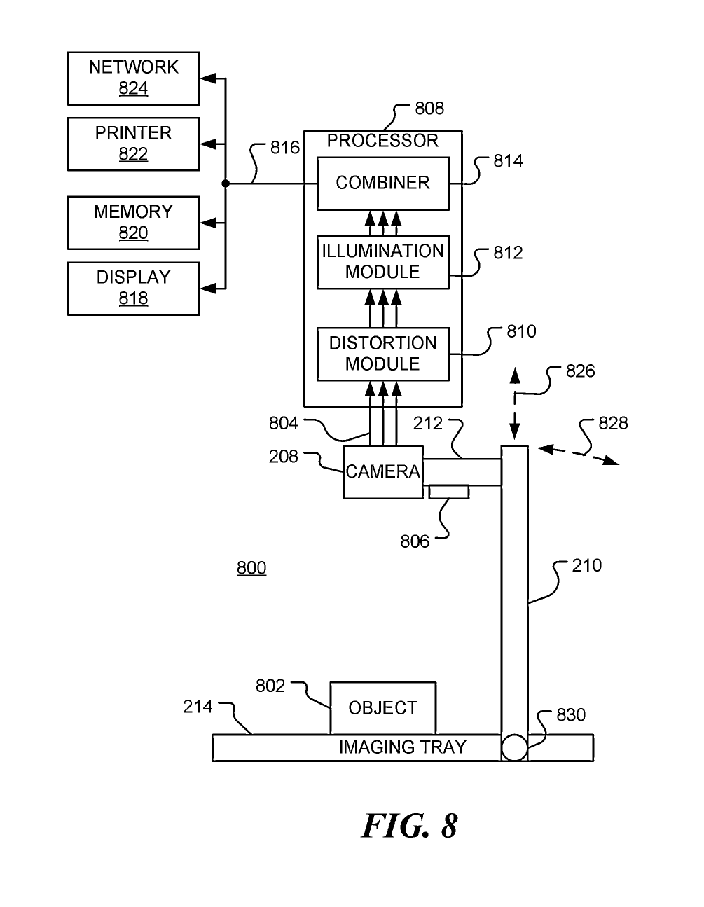

FIG. 8 is a block diagram of an exemplary apparatus 800 for acquiring a corrected digital image of an object 802, in accordance with certain aspects of the disclosure. A digital camera 208 is operable to capture a plurality of component images 804 corresponding to a plurality of color components of light from the object 802. The object is illuminated by an illumination source 806. An image processor 808 is operable to process the plurality of component images to produce a plurality of corrected component images, and includes a distortion correction module 810, an illumination correction module 812 and an image combiner 814, operable to combine the plurality of corrected component images to form the corrected digital image.

The corrected image is output from the processor at output 816 and may be passed to one or more of a display 818, a memory 820, a printer 822 and a network 824.

In one embodiment, the height of support arm 210 may be adjusted, as indicated by the broken arrow 826, so as to alter the perspective angle of camera 208. In addition, the support arm 210 may be coupled to the imaging try 214 via pivot joint 830 to enable the angle of the support arm 210 to be varied relative to the imaging tray 214, as indicated by the broken arrow 828.

The benefits of camera-based imaging over conventional scanning are that it is faster, silent, and lower power. In addition, a video display may be used to enable accurate document positioning and accurate focusing for thick documents and three dimensional objects. Still further, images from different camera positions may be used to obtain extended depth of focus or three-dimensional images.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. An apparatus for acquiring a corrected digital image of an object, the apparatus comprising:
a digital camera operable to capture a plurality of color component images corresponding to a plurality of color components of light from the object;
an imager body;
a support arm, coupled to the imager body and adapted to support the digital camera;
an image processor, operable to process the plurality of color component images to produce a plurality of corrected color component images; and
an image combiner, operable to combine the plurality of corrected color component images to form the corrected digital image.

2. An apparatus in accordance with claim 1, wherein the image processor comprises an illumination correction module and a distortion correction module for each of the plurality of color component images.

3. An apparatus in accordance with claim 1, wherein the digital camera comprises a pixel sensor array and a color filter mosaic.

4. An apparatus in accordance with claim 1, further comprising an illumination source operable to illuminate the object with at least one color component.

5. An apparatus in accordance with claim 1, further comprising:
a printer substantially housed within the imager body and operable to print the corrected digital image.

6. An apparatus in accordance with claim 1, wherein the support arm is coupled to the imager body via a pivot that enables the camera to be moved between first and second positions relative to the object.

7. An apparatus in accordance with claim 1, wherein the support arm has an adjustable length and is operable to vary the distance between digital camera and the object.

8. An apparatus in accordance with claim 7, further comprising a visual display operable to display a sequence of images that provide visual feedback to a user of the effect of changing the length of the support arm.

9. An apparatus in accordance with claim 7, wherein the image processor further comprises a module for combining corrected images acquired at different distances to produce an image with increased depth of focus.

10. An apparatus in accordance with claim 1, further comprising a means for varying the perspective angle of the camera relative to the object.

11. An apparatus in accordance with claim 10, wherein the image processor further comprises a module for forming a three-dimensional image by combining corrected images acquired at different perspective angles.

12. An apparatus in accordance with claim 1, further comprising a document imaging tray adapted to support an object to be imaged.

13. An apparatus in accordance with claim 1, wherein the document imaging tray is foldable along a hinge joint to enable the size of the document imaging tray to be reduced when not in use.

14. A method for forming a corrected digital image of an object, the method comprising;
capturing a first plurality of color component images of the object from a camera supported by a support arm and located at a first position relative to the object;
capturing a second plurality of color component images of the object from the camera supported by the support arm and located at one or more second positions relative to the object;
processing the first and second pluralities of color component images dependent upon the color of each color component image to produce first and second pluralities of corrected color component images; and
combining the first and second pluralities of corrected color component images to form the correct digital image.

15. A method in accordance with claim 14, wherein processing the first and second pluralities of color component images comprises correcting for distortions in the color component images.

16. A method in accordance with claim 14, wherein processing the first and second pluralities of color component images comprises correcting for non-uniformity in the illumination of the object dependent upon the color of the color component image.

17. A method in accordance with claim 14, wherein combining the first and second pluralities of corrected color component images comprises selecting between a pixel region in the first plurality of corrected color component images and a corresponding pixel region in the second plurality of corrected color component images dependent upon a measure of the focus in the corresponding pixel regions.

18. A method in accordance with claim 14, wherein the first plurality of color component images sensor corresponds to a plurality of interlaced color component images from a camera utilizing a color filter mosaic.

19. A method in accordance with claim 14, wherein capturing the first plurality of color component images of the object comprises:
for each light color of a plurality of light colors:
illuminating the object with the light color; and
capturing an image using a monochrome camera.

20. A method in accordance with claim 14, further comprising:
moving the camera automatically between locations of the first location and the one or more second locations.
